(19) United States
(12) Patent Application Publication
(10) Pub. No.: US 2015/0170320 A1
(43) Pub. Date: Jun. 18, 2015

(54) OPERATION OF A DISPLAY SYSTEM

(71) Applicant: Mount Pleasant House, Mount Pleasant, Cambridge (GB)

(72) Inventor: Paul James, Thurlby, Bourne, Lincolnshire (GB)

(73) Assignee: DisplayLink (UK) Limited, Cambridge (GB)

(21) Appl. No.: 14/401,518

(22) PCT Filed: May 2, 2013
(86) PCT No.: PCT/GB2013/051152

§ 371 Date: Nov. 15, 2014

(30) Foreign Application Priority Data
May 17, 2012 (GB) 1208687.2

(51) Int. Cl. G06T 1/20

(52) U.S. Cl. CPC G06T 1/20

(57) ABSTRACT

A display system comprises a processing device comprising a central processing unit connected to system memory and to a graphics processing unit, the processing device running an OS module and an IHV graphics driver. A method of operating the display system comprises the steps of installing an additional graphics driver, intercepting communications between the OS module and the IHV graphics driver at the additional graphics driver, identifying a request from the OS module to the IHV graphics driver for a shared primary allocation for a display source, replacing the identified request with a plurality of requests for a shared primary allocation for each display source supported by the graphics processing unit, receiving a plurality of responses from the IHV graphics driver to the plurality of requests, and providing a reply to the OS module derived from the received responses.

### RELATED APPLICATIONS

This application claims the benefit of both International Patent Application No. PCT/GB2013/051152, filed on May 2, 2013, and United Kingdom Patent Application No. 1208687.2, filed on May 17, 2012, both of which are incorporated by reference herein.

### TECHNICAL FIELD

This invention relates to a method of operating a display system, and to the display system itself.

### BACKGROUND

Microsoft Windows operating systems use a base driver model for graphics adapters that includes the concept of a Video Presentation Network, or VidPn. This concept includes video present sources, which are video frame buffer sources that the graphics adapter can display (which can be areas of a virtual desktop), and video present targets, which are physical video outputs or ports, such as the VGA or DVI connectors on a graphics adapter. A VidPn source contains changing pixel or video data. A VidPn target can display a source on a particular monitor or display device.

The VidPn also defines a topology that describes the connections between sources and targets, i.e. which targets are displaying which sources at any given time. Each source and target has a unique ID, which identifies it to both the operating system and the graphics driver. A given graphics adapter driver must express to the operating system which paths are permitted or supported between sources and targets. It is possible, however, to add a second, additional, driver that adds further sources and targets to those presented by the underlying graphics adapter driver, for example to support hot-pluggable USB displays. The operating system must be aware of these added sources and targets so they can be fully part of the operating system display and virtual desktop setup.

An issue with the addition of a second driver relates to the permitted mappings reported to the operating system by the base graphics adapter driver (an IHV graphics driver). Taking an example where the underlying IHV graphics driver presents two sources (S1, S2) and two targets (T1, T2), and the second driver adds two further sources (S3, S4) and two further targets (T3, T4), the original graphics adapter driver is unaware of the added sources and targets, so it is important that the IHV graphics driver is not aware of mappings from S1 or S2 to T3 or T4.

### SUMMARY

It is therefore an object of the invention to improve upon the known art.

According to a first aspect of the present invention, there is provided a method of operating a display system comprising a processing device comprising a central processing unit connected to system memory and to a graphics processing unit, the processing device running an OS module and an IHV graphics driver, the method comprising the steps of installing an additional graphics driver, intercepting communications between the OS module and the IHV graphics driver at the additional graphics driver, identifying a request from the OS module to the IHV graphics driver for a shared primary allocation for a display source, replacing the identified request with a plurality of requests for a shared primary allocation for each display source supported by the graphics processing unit, receiving a plurality of responses from the IHV graphics driver to the plurality of requests, and providing a reply to the OS module derived from the received responses.

According to a second aspect of the present invention, there is provided a display system comprising a processing device comprising a central processing unit connected to system memory and to a graphics processing unit, the processing device running an OS module and an IHV graphics driver wherein an additional graphics driver is installed, the additional graphics driver arranged to intercept communications between the OS module and the IHV graphics driver, identify a request from the OS module to the IHV graphics driver for a shared primary allocation for a display source, replace the identified request with a plurality of requests for a shared primary allocation for each display source supported by the graphics processing unit, receive a plurality of responses from the IHV graphics driver to the plurality of requests, and provide a reply to the OS module derived from the received responses.

Owing to the invention, it is possible to provide an additional driver that will provide a layer of virtualisation between the naming of the sources and targets, which will allow the existing components to function normally. The invention provides the virtualisation of shared primary allocations to avoid creating incorrect allocations as a way of virtualising shared primary allocations to support more VidPn sources than an IHV (independent hardware vendor) graphics driver exposes by creating all possible permutations at create time and choosing the allocations to use later.

IHV graphics drivers know about and expect to see references to a certain number of VidPn source ids, typically two. In order to support extra displays, the additional graphics driver will tell the operating system, run by the central processing unit, that there are more than the IHV driver reports, but then hide information about these ids from the IHV driver to avoid crashes. A shared primary allocation is created for a specific VidPn source id, so the way that the additional graphics driver hides information about the extra source ids is by changing the arguments passed through to the IHV function, to always be within the range the IHV driver expects. At create time, it is not possible to know which VidPn target a shared primary allocation will be connected to, so the additional graphics driver does not know if it should create an allocation with the correct VidPn source id from the IHV driver's perspective (the source ids are virtualised, for example, source id 3 could be connected to an IHV target so in the additional graphics driver it is swapped to 1) or just set it to 0. The additional graphics driver will use 0 for all extra allocations as an IHV driver will always expose at least 1 source and the source ids are a 0-based integer range.

This improved method involves the additional graphics driver asking the IHV driver to create multiple shared primary allocations in response to a single create request from the operating system, as opposed to creating a single allocation but trying to guess which VidPn source id should be passed to the IHV driver. This is possible as multiple allocations are not actually made, the IHV driver just provides a description of how the allocation can be made and manipulated, which is used by the operating system's video memory manager. This means there is no potential to get into the situation where an allocation that the IHV driver would expect to have been created with source id 1 was actually created with source id 0.

### BRIEF DESCRIPTION OF THE DRAWINGS

Embodiments of the present invention will now be described, by way of example only, with reference to the accompanying drawings, in which:

FIG. 1 is a schematic diagram of a system using two display devices,

FIG. 2 is a schematic diagram of a processing device,

FIG. 3 is a schematic diagram of a graphics processing unit,

FIG. 4 is a schematic diagram of software modules within the display system, and

FIG. 5 is a further schematic diagram of software modules.

### DETAILED DESCRIPTION

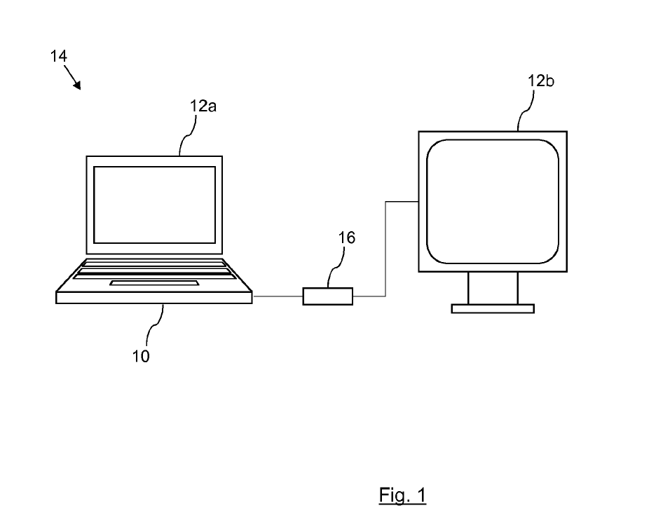

FIG. 1 shows a processing device 10 that is connected to two display devices 12. The processing device 10 is the processing part of a conventional laptop computer 14 that is connected to a primary display device 12a. In addition, the processing device 10 is also connected to an additional display device 12b, which is an external monitor 12b. The monitor 12b is connected to the laptop 14 via a USB connection through an adaptor 16. The processing device 10 controls the images that are shown on the display devices 12. The purpose of the arrangement shown in FIG. 1 is to take advantage of the extra display area provided by the display device 12b in order to increase the available display area for a user.

The hardware 16 that is connected to the USB port of the laptop 14 is a device with a purpose-built chip, which can be an adapter or a docking station. A monitor that supports a direct USB connection can be used if it has the necessary chip built-in. Any additional standard monitor that a user wishes to connect to their laptop 14 is simply connected through a suitable device 16 with the necessary chip and therefore there is no extra graphics adapter required in the laptop 14, nor any other resource such as additional CPU, GPU or memory, etc. The adaptor 16 provides the necessary hardware and software to be able to utilise a USB output from the laptop 14 for the purpose of showing high-resolution graphics (including video) on an additional monitor 12b. On the output side of the adaptor 16, a VGA output can be provided to connect to the standard VGA socket provided on the display device 12b.

The additional display device 12b can be controlled to show exactly the same image that is being shown by the primary display device 12a. However, the greatest advantage for the user can be achieved by controlling the two display devices 12a and 12b in order that they show different images. The user's desktop can be split, so that the left half is shown by the primary display device 12a and the right half can be shown by the additional display device 12b. The user can navigate between the two display devices 12b as if they were a single continuous display device. For example, the user can move an on-screen cursor “off” one display device and “onto” the other display device, in an intuitive fashion. Application windows can be moved around the desktop without limitation.

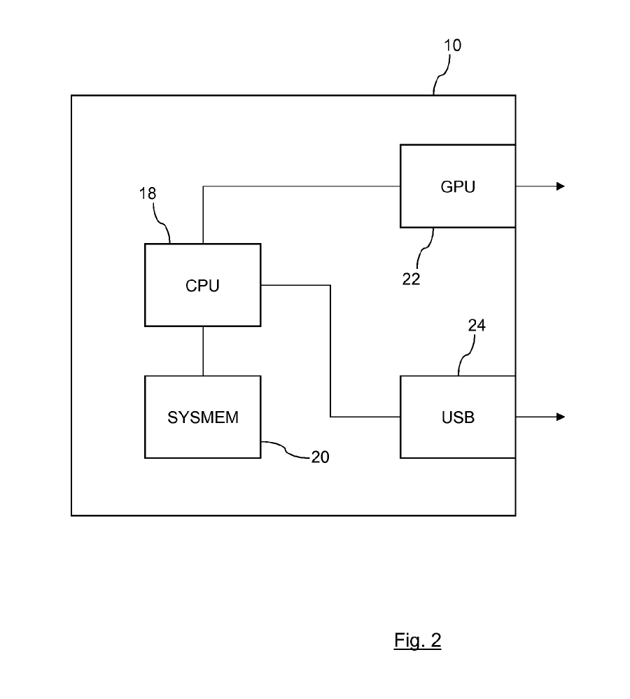

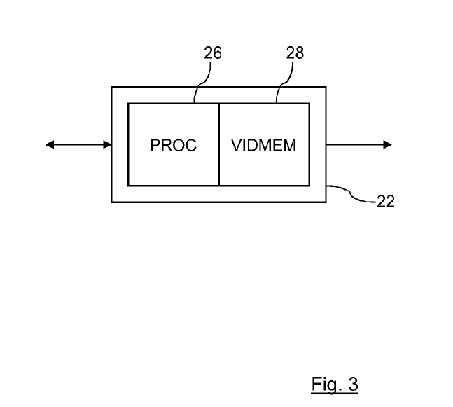

FIG. 2 shows more detail of the processing device 10. Various internal components of the processing device 10 are shown, but it will be appreciated that a large number of additional components have been omitted for reasons of clarity. The processing device 10 comprises a processor 18 that is connected to a system memory 20 and to a graphics processing unit 22. The processor 18 is also connected to a USB hub 24. The graphics processing unit 22 comprises a graphics processor 26 connected to a video memory 28 (shown in FIG. 3) and has an external VGA connection which is used to drive the primary display device 12a. Through the USB hub 24, the processor 18 is driving the additional display device 12b. In this way, an additional display device 12b can be controlled, through the adaptor 16, without needing an additional GPU in the laptop 14.

Traditionally, the only way to add an additional display device to a standard desktop computer or laptop computer was to physically install an additional GPU in the computer, which would provide an additional VGA out connection, to which the additional display device could be connected. In the system shown in FIGS. 1 and 2, no additional hardware is required in the laptop 14 to connect and operate the additional display device 12b from the laptop 14, as virtually all laptops and desktop computers are provided with multiple USB connections (commonly 4, 6 or 8). However, this arrangement creates greater processing demand, as USB is a bandwidth limited connection protocol that was not designed for the heavy graphics that is common in today's desktop computing. For example, the provision of acceptable quality real-time video over USB is a non-trivial task.

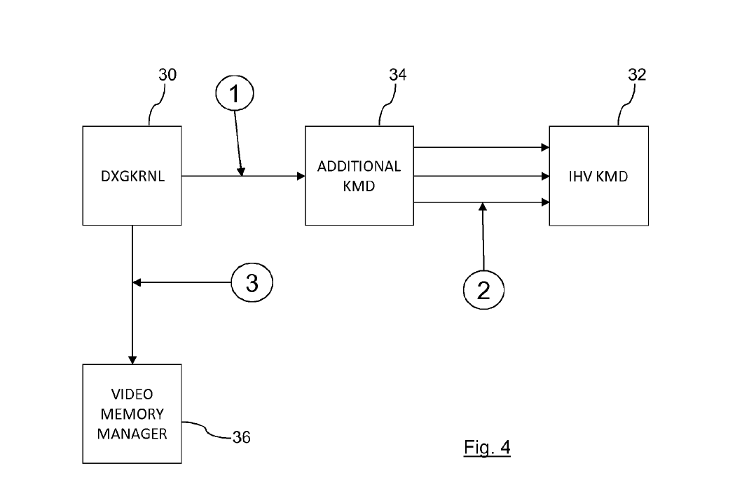

FIG. 4 shows the software modules that are used to add in an additional display device, in the case of a Microsoft Windows operating system. The operating system module 30 communicates with an IHV driver 32, through the additional driver 34. The OS module 30 also communicates with a video memory manager 36. The OS module 30, labelled DXGKRNL, is part of the operating system, i.e. is written by Microsoft, and is the module 30 that calls into the kernel mode driver 32 to, among other things, create shared primary allocations. The additional driver 34, labelled DLKMD, is a kernel driver component that is used to intercept calls intended for the IHV driver 32. The driver 32, labelled IHV KMD, is the kernel mode driver component provided by the IHV (such as Intel, nvidia or AMD). The video memory manager 36 is the part of the operating system that manages the memory available to the GPU 22. Note that the kernel mode drivers 32 and 34 do not communicate directly with the video memory manager 36 but some of the information returned to OS module 30 will be used by the video memory manager 36.

The numbers in circles on the Figure refer to the steps being taken in the process of setting up the vitualisation of the sources and targets in the video present network, in order that the IHV driver 32 will work properly without receiving instructions for sources and/or targets that it does not support. At step 1, the operating system module 30 asks the IHV driver 32 to create a shared primary allocation for a specific VidPn source id. At step 2, the additional kernel module 34 calls the IHV driver 32, n times where n is the number of sources the IHV driver 32 reported earlier. The information returned in each of these calls is condensed into a single set of data and returned to the operating system module 30. At step 3, the video memory manager 36 is told about how the graphics driver 32 defined the shared primary allocation based on the information returned in the create allocation call.

Essentially, the additional graphics driver 34 intercepts communications between the OS module 30 and the IHV graphics driver 32, identifies a request from the OS module 30 to the IHV graphics driver 32 for a shared primary allocation for a display source and replaces the identified request with a plurality of requests for a shared primary allocation for each display source supported by the graphics processing unit 22. The additional graphics driver receives a plurality of responses from the IHV graphics driver 32 to the plurality of requests, and provides a reply to the OS module 30 derived from the received responses.

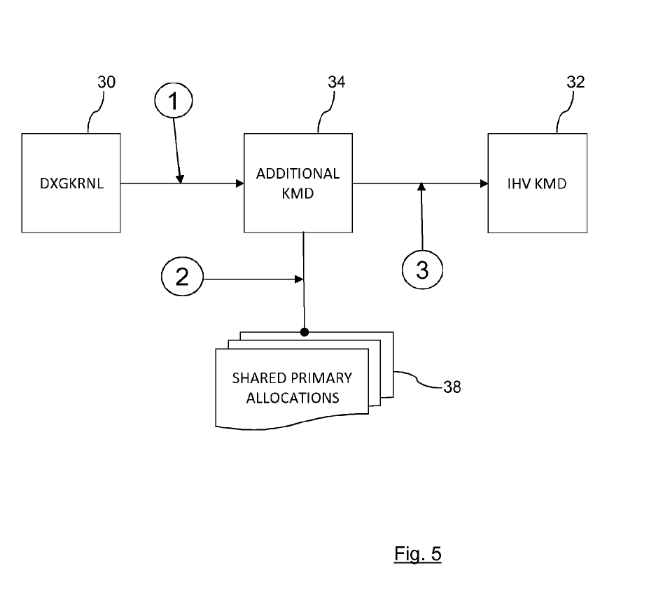

A single call from the OS module 30 is turned into multiple calls to the IHV driver 32 but once the shared primary allocations are created then only make single calls are needed to the IHV driver 32 when a shared primary allocation is referenced, as it is possible to chose which one from the set available that is actually wanted to be used. This is illustrated in FIG. 5.

This Figure shows how the shared primary allocations 38 are handled, after the creation shown in FIG. 4. At step 1, the operating system module 30 makes a call that refers to a shared primary allocation 38, for example, DdiPresent. The additional kernel module 34 selects the shared primary allocation 38 that it has now decided it wishes to use from the set previously created. At step 3, the additional driver 34 forwards the operating system's call to the IHV driver 32, having modified the parameters to indicate which shared primary allocation the additional driver 34 wants the IHV driver 32 to use. In this way the matching of a shared primary allocation 38 to a video present source that will be used by the IHV driver 32 will be controlled by the additional driver 34.

1. A method of operating a display system comprising a processing device comprising a central processing unit connected to system memory and to a graphics processing unit, the processing device running an OS module and an IHV graphics driver, the method comprising the steps of:
installing an additional graphics driver,
intercepting communications between the OS module and the IHV graphics driver at the additional graphics drive,
identifying a request from the OS module to the IHV graphics driver for a shared primary allocation for a display source,
replacing the identified request with a plurality of requests for a shared primary allocation for each display source supported by the graphics processing unit,
receiving a plurality of responses from the IHV graphics driver to the plurality of requests, and
providing a reply to the OS module derived from the received responses.

2. A method according to claim 1, wherein the step of providing a reply to the OS module derived from the received responses comprises providing a single reply to the OS module comprising information from all of the received plurality of responses.

3. A method according to claim 1, and further comprising identifying a request from the OS module to the IHV graphics driver for a specific shared primary allocation and replacing the identified request with a single request for a different shared primary allocation.

4. A method according to claim 1, and further comprising receiving the reply at the OS module and communicating with a video memory manager in relation to memory allocation for the different shared primary allocations.

5. A display system comprising a processing device comprising a central processing unit connected to system memory and to a graphics processing unit, the processing device running an OS module and an IHV graphics driver wherein an additional graphics driver is installed, the additional graphics driver arranged to:
intercept communications between the OS module and the IHV graphics driver,
identify a request from the OS module to the IHV graphics driver for a shared primary allocation for a display source,
replace the identified request with a plurality of requests for a shared primary allocation for each display source supported by the graphics processing unit,
receive a plurality of responses from the IHV graphics driver to the plurality of requests, and
provide a reply to the OS module derived from the received responses.

6. A system according to claim 5, wherein the additional graphics driver is arranged, when providing a reply to the OS module derived from the received responses, to provide a single reply to the OS module comprising information from all of the received plurality of responses.

7. A system according to claim 5, wherein the additional graphics driver is further arranged to identify a request from the OS module to the IHV graphics driver for a specific shared primary allocation and replace the identified request with a single request for a different shared primary allocation.

8. A system according to claim 5, wherein the OS module is arranged to receive the reply from the additional graphics driver and communicate with a video memory manager in relation to memory allocation for the different shared primary allocations.
